(19) United States
(12) Patent Application Publication
(10) Pub. No.: US 2009/0201171 A1
(43) Pub. Date: Aug. 13, 2009

(54) SMALL IN-HOME UTILITY SERVICES DISPLAY DEVICE

(76) Inventors: Paul DeMartini, North Tustin, CA (US); Paul Kasick, Los Angeles, CA (US); John Bubb, Newport Beach, CA (US)

Correspondence Address: SHELDON MAK ROSE & ANDERSON PC, 100 Corson Street, Third Floor, PASADENA, CA, 91103-3842, US

(21) Appl. No.: 12/027,810

(22) Filed: Feb. 7, 2008

(51) Int. Cl. G09F 25/00; G08C 15/06

(52) U.S. Cl. 340/870.02; 340/286.01

(57) ABSTRACT

A display device useful in displaying information transmitted by a utility to its customer location via a utility communication network has a generally planar body defining a face area less than about 25 square inches, a circuit board, an unlicensed band radio frequency communications receiver, a power source (such as a battery), a display screen and an attachment component (such as a magnet).

### FIELD OF THE INVENTION

This invention relates generally to small in-home display or warning devices.

### BACKGROUND OF THE INVENTION

Many utility companies, such as electrical utility companies, are rapidly moving forward toward developing a utility communication network with which to communicate with each of their individual customer locations. An example of this is the movement by many utilities to change out its conventional utility usage meters and replace them with so-called “smart meters.” “Smart meters” provide the utility with the ability to interactively communicate with each of its customer locations. Several methods of using such smart meters are set forth in U.S. patent application Ser. No. 11/626,810, filed Jan. 24, 2007, entitled “Method of Communicating Between a Utility and Its Customer Locations,” which is incorporated herein by this reference.

A problem in communicating with customer locations using such utility communication networks exists in providing customer locations with convenient “consoles” with which to receive information from a utility via a utility communication network. Smart meters, for example, are typically disposed apart from the interior of the customer location. Large or hard wired consoles providing communication between a smart meter and the interior of a customer location is awkward, expensive and aesthetically non-pleasing to the customer.

Accordingly, there is a need for a method and device for conveniently and efficiently providing information from a utility to a customer location via a utility communication network.

### SUMMARY

The invention satisfies this need. The invention is a display device useful in displaying information transmitted by a utility to its customer location via a utility communication network, the display device comprising (a) a body having a width, a length and a depth, the width and length defining a face area less than about 25 square inches, and the depth being less than about 1 inch; (b) a circuit board disposed within the body; (c) an unlicensed band radio frequency communication receiver disposed within the body; (d) a power source; (e) display means disposed on the exterior of the body; and (f) means affixed to the body for attaching the display device to an appliance or wall.

### DRAWINGS

These and other features, aspects and advantages of the present invention will become better understood with reference to the following description and accompanying drawings where:

FIG. 1 is a perspective view of a generic display device having features of the invention;

FIG. 2 is a first specific example of a small in-home display device having features of the invention;

FIG. 3 is a second specific example of a small in-home display device having features of the invention;

FIG. 4 is a third specific example of a small in-home display device having features of the invention;

FIG. 5 is a fourth specific example of a small in-home display device having features of the invention;

FIG. 6 is a fifth specific example of a small in-home display device having features of the invention;

FIG. 7 is a sixth specific example of a small in-home display device having features of the invention; and

FIG. 8 is a seventh specific example of a small in-home display device having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a small in-home utility services display device. The display device is ideal for use with a method of communicating between a utility and its customer locations via a utility communication network as described in the aforementioned U.S. patent application Ser. No. 11/626,810.

In one such method of communicating between a utility and its customer locations, information transmitted to a customer location is provided to a first site at the customer location via an integrated radio frequency communications portal which sends and receives information from a potentially diverse echo system of discrete communications devices such as, in the case of an electrical utility, electrical appliances and other electrical equipment located at the customer locations. In one example, this is accomplished with an advanced utility meter disposed at the first site, typically on the exterior of the customer location. The information communicated to the customer using the method of communicating between a utility and its customer locations can include a large variety of energy usage and/or price related data. Where an advanced utility meter is employed, the advanced utility meter can provide a gateway or a central hub between the utility and the customer location.

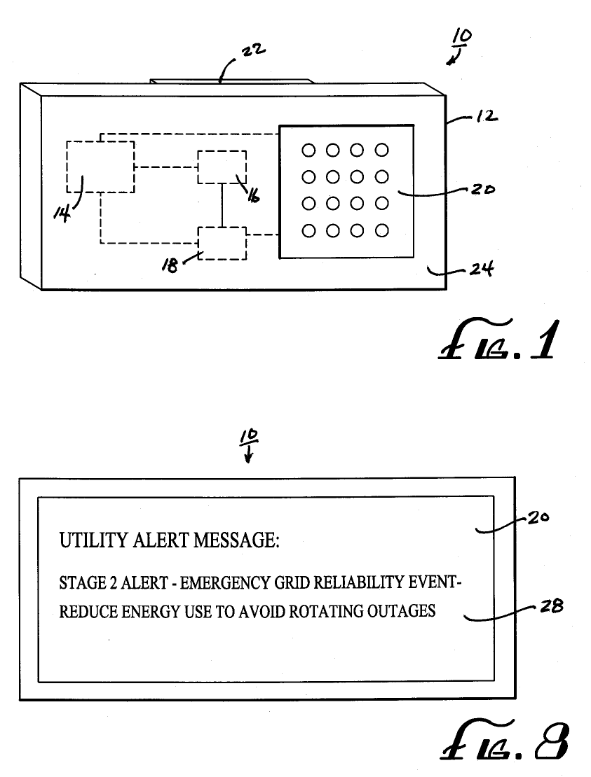

As illustrated in FIG. 1, the display device 10 of the invention comprises a body 12, a circuit board 14, an unlicensed band radio frequency communications chip 16, an A/C or D/C power source 18, display means 20, and means 22 for conveniently attaching the display device 10 to an appliance or wall within the customer location.

The body 12 is typically made of a light material, such as a plastic. The body 12 has a width, a length and a depth. The width and length of the body 12 define a face area 24 which is less than about 25 square inches, typically between about 10 square inches and about 20 square inches. The body 12 has a depth which is less than about 1 inch, typically less than about ¾ inch.

The unlicensed band radio frequency communications chip 16 is tuned to receive radio signals from a utility communications network, such as from an advanced utility meter.

The display means 20 is typically an LED array 26, but other display means 20, such as an LCD screen 28, can also be used. Also, a wide variety of audio alert means and other alert means, such as alert means employed in cell phones, can be used either with the display means 20, or as a stand-alone communications method.

The means 22 for attaching the display device 10 at the customer location can comprise a magnetized element adapted to facilitate the use of the display device 10 as a “refrigerator magnet.” Other means 22 for attaching the display device 10 within the customer location can also be used, such as a “peel-and-stick” adhesive backing or hook and loop attachment components, such as Velcro® brand hook and loop attachment components. Also, the means 22 for attaching the display device 10 at the customer location can comprise an A/C connector plug capable of securing the display device 10 to an outlet in a wall at the customer location.

The circuit board 14 is adapted to provide appropriate circuitry to electrically connect the unlicensed band radio frequency communications chip 16, the power source 18 and the display means 20.

Typically, the display device 10 weighs less than about 12 ounces. In devices powered by a battery, the display device 10 without the battery typically weighs less than 8 ounces. Even with a battery disposed within the body 12, many display devices 10 of the invention weigh less than about 8 ounces.

As noted above, the display device 10 of the invention can be conveniently used to provide the utility customer with a visual indication and/or audio alert of near-real-time energy utility costs and other information. In devices wherein the display means 20 comprises an LED array 26, the LEDs can serve to provide an indication of current or pending utility pricing. The intermittent or constant illumination of one or more of the LEDs on the display device 10 can directly correspond with a near-real-time energy pricing time period, such as a “high” cost period, a “low” cost period and/or a plurality of cost classifications in between. The display devices 10 can also be used to provide customers with utility cost forecasts covering the near future.

The display device 10 of the invention can be adapted to provide customer-specific energy usage (or consumption) information, historical energy consumption for a user-configurable time period, environmental impact information, and/or text-based communications from the utility.

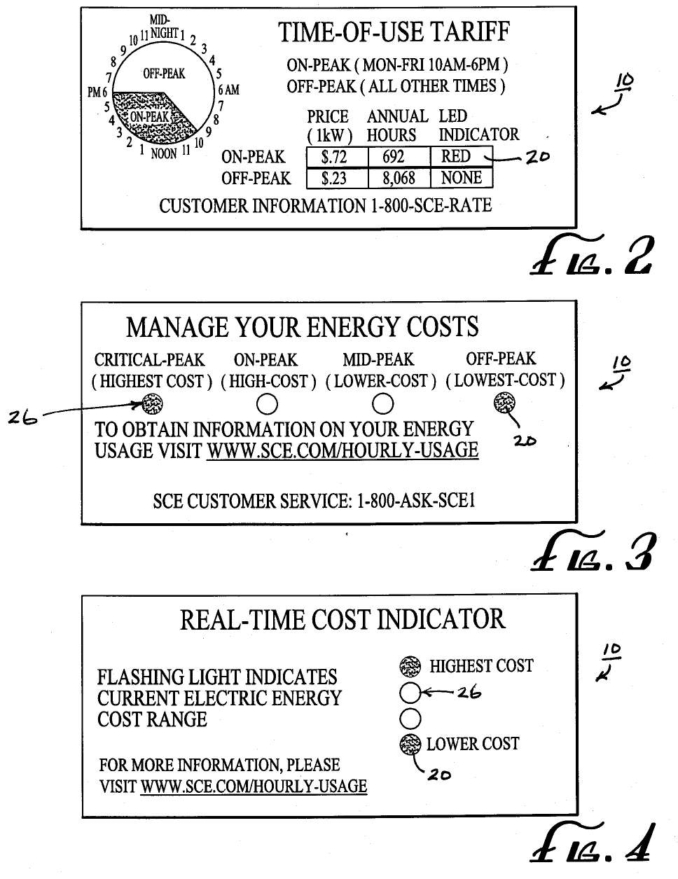

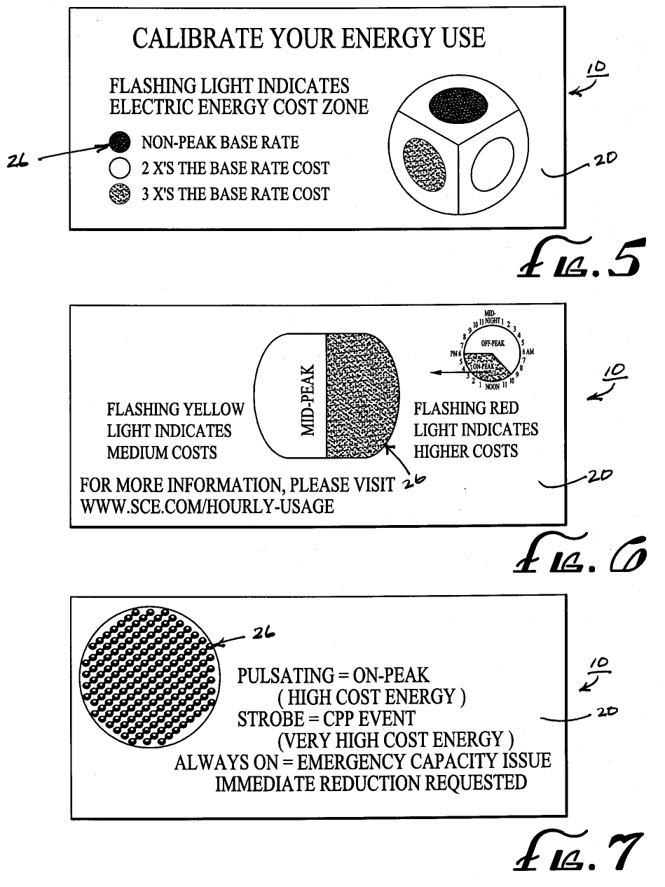

FIGS. 2-8 illustrate a variety of different display device 10 embodiments of the invention usable by an electric utility to provide its customers with information regarding electrical energy costs and other important information.

The display devices 10 can also be used to improve the ability to send and receive information between the utility communications network and other in-home devices through the ability of the display units to “mesh” with such other devices and facilitate the routing of information among such other devices. The display devices 10 can also be used to facilitate signal hopping among and between such devices. Thus, the use of the display units of the invention provides the in-home wireless network at each customer location to be more robust and reliable.

Having thus described the invention, it should be apparent that numerous structural modifications and adaptations may be resorted to without departing from the scope and fair meaning of the instant invention.

What is claimed is:

1. A display device useful in displaying information transmitted by a utility to its customer locations via a utility communication network, the display device comprising:
(a) a body having a width, a length and a depth, the width and length defining a face area less than about 25 square inches, and the depth being less than about 1 inch;
(b) a circuit board disposed within the body;
(c) an unlicensed band radio frequency communication receiver disposed within the body;
(d) a power source;
(e) display means disposed on the exterior of the body; and
(f) means affixed to the body for attaching the display device to an appliance or wall.

2. The display device of claim 1 wherein the width and length of the body define a face area between about 10 square inches and about 20 square inches.

3. The display device of claim 1 wherein the display device weights less than about 12 ounces.

4. The display device of claim 1 wherein the display device weights less than about 8 ounces.

5. The display device of claim 1 wherein the means for attaching the display device to an appliance or wall is a magnet.

6. The display device of claim 1 wherein the means for attaching the display device to an appliance or wall is a peel and stick strip.

7. The display device of claim 1 wherein the means for attaching the display device to an appliance or wall is a hook and loop portion.

8. The display device of claim 1 wherein the power source is disposed within the body and comprises a source of direct current.

9. The display device of claim 1 wherein the power source is disposed within the body and comprises a battery.

10. The display device of claim 1 wherein the power source comprises an alternating current connection.

11. The display device of claim 1 wherein the power source comprises an alternating current connection and the means for attaching the display device to an appliance or wall comprises an A/C connector plug.

12. The display device of claim 1 wherein the unlicensed band radio frequency communications receiving chip is tuned to receive radio signals sent from a utility communication network.

13. The display device of claim 1 wherein the display means comprises LED units.

14. The display device of claim 1 wherein the display means is an LCD screen.

15. A method for communicating between a utility and one of the utility's customer locations using a utility communication network, the method comprising the steps of:
(a) providing the customer location with a display device comprising:
(i) a body having a width, a length and a depth, the width and length defining a face area less than about 25 square inches, and the depth being less than about 1 inch;
(ii) a circuit board disposed within the body;
(iii) an unlicensed band radio frequency communication receiver disposed within the body;
(iv) a power source;
(v) display means disposed on the exterior of the body; and
(vi) means affixed to the body for attaching the display device to an appliance or wall;
(b) transmitting information from the utility to a customer location via the utility communication network to a first site at the customer location;
(c) re-transmitting the information from the first site to the display device disposed at a second site at the customer location using an unlicensed band radio frequency communications transmitter disposed at the first site; and
(d) displaying the information on the display means of the display device.

16. The method of claim 14 where an advanced utility meter is disposed at the first site at the customer location, information transmitted from the utility in step (b) is transmitted to the advanced utility meter, and the re-transmission of the information in step (c) is accomplished using an unlicensed band radio frequency communication transmitter disposed within the advanced utility meter.
